(19) United States
(12) Patent Application Publication
(10) Pub. No.: US 2020/0394575 A1
(43) Pub. Date: Dec. 17, 2020

(54) INFORMATION PROCESSING SYSTEM AND NON-TRANSITORY COMPUTER READABLE MEDIUM STORING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/598,367

(22) Filed: Oct. 10, 2019

(30) Foreign Application Priority Data
Jun. 17, 2019 (JP) 2019-112199

(51) Int. Cl. G06Q 10/06; G06Q 10/02; G06K 9/00

(52) U.S. Cl. CPC G06Q 10/06; G06K 9/00255; G06Q 10/02

(57) ABSTRACT

An information processing system includes a reserving person information acquisition unit that acquires information on a reserving person of a reservation for a place, a user information acquisition unit that acquires information on a user who has come to the place, and an output unit that outputs an instruction to record attendance information of the user if the reserving person and the user match each other based on the acquired information on the reserving person and the acquired information on the user.

### CROSS-REFERENCE TO RELATED APPLICATIONS

This application is based on and claims priority under 35 USC 119 from Japanese Patent Application No. 2019-112199 filed Jun. 17, 2019.

### BACKGROUND

### (i) Technical Field

The present disclosure relates to an information processing system and a non-transitory computer readable medium storing a program.

### (ii) Related Art

For example, Japanese Unexamined Patent Application Publication No. 2014-89607 discloses an information processing apparatus that creates and stores data related to sales recording. The information processing apparatus includes an end time/date input unit and a notification unit. The end time/date input unit receives an input of the end time and date of user's work. When the data related to sales recording is created after the end time and date of work have been input to the end time/date input unit, the notification unit gives a notification to prompt the user to input the end time and date of work.

### SUMMARY

Aspects of non-limiting embodiments of the present disclosure relate to the following circumstances. If a person records his/her attendance information by himself/herself, he/she may record false attendance information. For example, the person may record information indicating that the person came to his/her workplace, even though the person did not come to his/her workplace.

When a place where someone uses (e.g., a place where someone works) needs a reservation, it is desirable that attendance information of a person registered as a person who is expected to use the place be recorded without the person having to remember his/her activities conducted in the place.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system comprising a reserving person information acquisition unit that acquires information on a reserving person of a reservation for a place, a user information acquisition unit that acquires information on a user who has come to the place, and an output unit that outputs an instruction to record attendance information of the user if the reserving person and the user match each other based on the acquired information on the reserving person and the acquired information on the user.

### BRIEF DESCRIPTION OF THE DRAWINGS

An exemplary embodiment of the present disclosure will be described in detail based on the following figures, wherein:

FIG. 1 schematically illustrates an example of the overall configuration of an information processing system according to an exemplary embodiment;

FIG. 2 illustrates an example of a booth type space;

FIG. 3 illustrates an example of the hardware configuration of each management server for use in the exemplary embodiment;

FIG. 4 illustrates an example of the hardware configuration of a user terminal;

FIG. 5 illustrates an example of the functional configuration of a space management server;

FIG. 6 is a flowchart illustrating an example of a procedure of processing to be performed by the space management server;

FIGS. 7A to 7C illustrate specific examples of the processing to be performed by the space management server;

FIG. 8 illustrates an example of processing to be performed when a person exits from a space and then enters a different space; and

FIG. 9 illustrates an example of processing to be performed when activity information is recorded as attendance information.

### DETAILED DESCRIPTION

An exemplary embodiment of the present disclosure is described below with reference to the drawings.

### <Overall Configuration of Information Processing System>

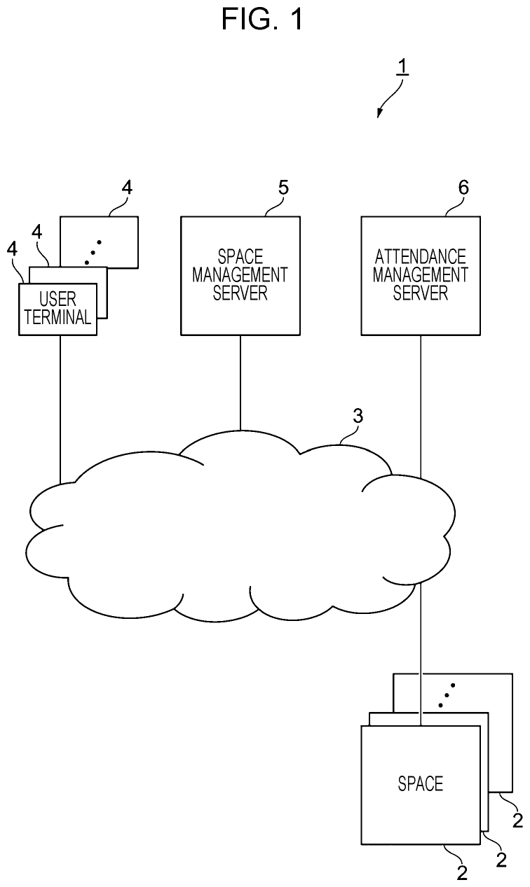

FIG. 1 schematically illustrates an example of the overall configuration of an information processing system 1 according to this exemplary embodiment. The information processing system 1 according to this exemplary embodiment includes various apparatuses and spaces 2 connected to a cloud network 3.

The spaces 2 include a booth, a room of an accommodation or the like, and a conference room of a company or the like. The spaces 2 may be movable spaces such as an automobile. Those spaces are examples of a space demarcated from surroundings with walls, partitions, or the like. The spaces 2 include a table and a seat in a restaurant or the like where a service is provided. Those spaces are examples of a space open to surroundings. Thus, the space 2 of this exemplary embodiment only needs to be a place available to a user and the type of the place is not limited.

The space 2 of this exemplary embodiment is assigned a name, a number, or the like for management. Reservations for the space 2 may be chargeable or free of charge.

If an electronic lock is attached to a door of the space 2, the space 2 is available under a condition that the user has an electronic key provided in advance. If the space 2 has no door, the space 2 is available, for example, under a condition that the reserving person is authenticated by using an authentication code provided in advance or a manager of the space 2 verifies the name of the reserving person.

Reservations for the space 2 may be made by a person who is expected to use the space 2. Alternatively, someone else may make the reservation on behalf of the person who is expected to use the space 2. A user registered as a person who is expected to use the space 2 is hereinafter referred to as a “reserving person”. For example, in a case where someone makes a reservation on behalf of a person who is expected to use the space 2, the “reserving person” is the person expected to use the space 2.

In this exemplary embodiment, a plurality of spaces 2 are provided as examples of the place for reservation.

As examples of the apparatuses connected to the cloud network 3, FIG. 1 illustrates user terminals 4 operated by users, a space management server 5 that manages the spaces 2, and an attendance management server 6 that manages users' attendance information.

In the case of FIG. 1, one server is prepared for each purpose or function. That is, one space management server 5 and one attendance management server 6 are prepared.

A plurality of servers may be prepared for one purpose or function or one server may be shared for a plurality of purposes or functions.

The number of business entities that manage a certain space 2 may be one or plural. For example, different business entities may individually have responsibilities for management of reservations, management of entry/exit and usage of rooms, management of charges for use on users, and management of members registered as users.

As described above, the spaces 2 to be managed for reservation need not be the same type of space. For example, a subset of the spaces 2 may be booths and another subset of the spaces 2 may be a seat and a table in a restaurant or the like.

A plurality of business entities may offer management of one purpose or function in cooperation.

The user terminal 4 is an apparatus to be used by a user. In this exemplary embodiment, the user terminal 4 is assumed to be a smartphone to be carried by a user. The portable user terminal 4 may be a so-called wearable terminal, a notebook computer, or a game console.

The space management server 5 manages various types of information related to reservations for the space 2, and various types of information related to a use of the space 2.

For example, a user inputs information and communicates with the space management server 5 by causing the user terminal 4 to start an application or groupware to be used for making reservations for the space 2. Thus, various types of information related to reservations for the space 2 are stored in the space management server 5.

For example, various types of information related to a use of the space 2 are acquired by apparatuses such as an image capturing apparatus 24, a motion sensor 25, and an information acquisition apparatus (not illustrated) described later. The acquired pieces of information are sequentially output to the space management server 5 and stored in the space management server 5.

Specifically, examples of various types of information related to reservations for the space 2 include information on a reserving person of each reservation for the space 2, information on the reserved space 2, and start time and date and end time and date of a time frame reserved by each reservation. Examples of the information on a reserving person of each reservation for the space 2 include a name, sex, and age of the reserving person, an organization such as a company, an employee's ID, an account, a password, individual management information, information on the face of the reserving person, and a fingerprint and a vein pattern of the reserving person. For example, the information on the face is an image of the face and is used as an example of biological information together with the fingerprint and the vein pattern. Examples of the information on the reserved space 2 include information on an address, a location, a management name, and a management number of the space 2.

Examples of various types of information related to a use of the space 2 include information on a user who has come to the space 2, information on the space 2, and start time and date and end time and date of each use. Examples of the information on a user who has come to the space 2 include information on the face of the user that is obtained by capturing an image of the user, information obtained from an ID card (for example, a name, sex, and age of the user, an organization such as a company, an employee's ID, an account, a password, individual management information, and information on the face of the user), and a fingerprint and a vein pattern of the user. Examples of the information on the space 2 include information on an address, a location, a management name, a management number, a noise level, and a temperature of the space 2.

The space management server 5 may manage reservations for goods and services associated with the space 2. For example, the space management server 5 may manage items for rent, and goods and services sold and/or consumed at the space 2.

The attendance management server 6 manages user's attendance information. The attendance information is information related to attendance of a user. Examples thereof include information on a working period, breaks, a start time of work, and an end time of work for the user. For example, the attendance management server 6 is managed by an organization such as a company to which the user belongs. In this case, the attendance management server 6 exists in each organization. Although details are described later, if the reserving person and the user of the space 2 match each other, the space management server 5 of this exemplary embodiment outputs, to the attendance management server 6, an instruction to record attendance information of the user of the space 2 (that is, the reserving person of the reservation for the space 2). When the instruction is received, the attendance management server 6 records the attendance information of the user of the space 2 (that is, the reserving person of the reservation for the space 2).

### <External Structure of Space>

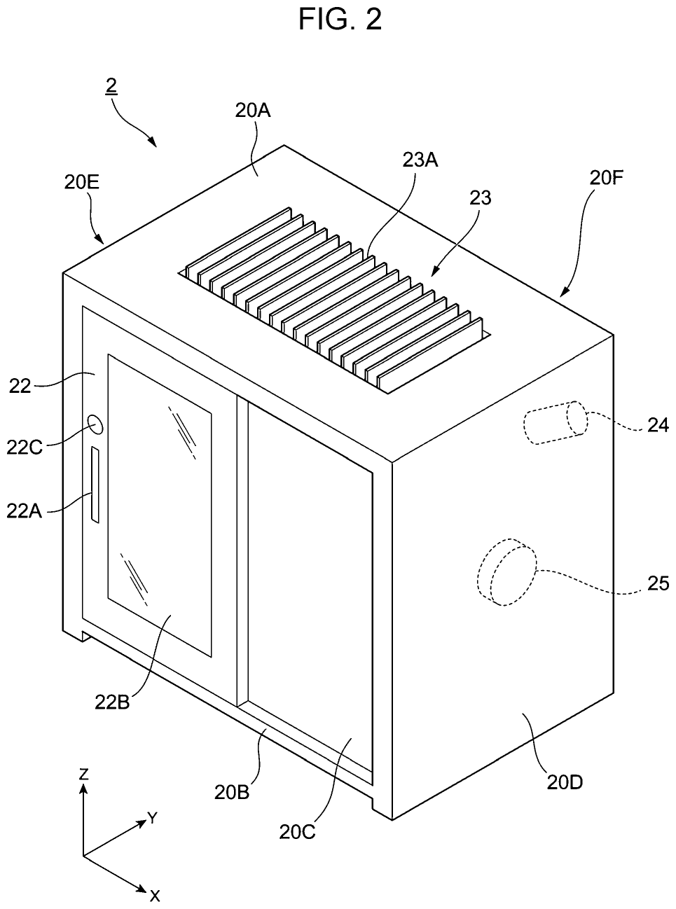

FIG. 2 illustrates an example of a booth type space 2. The booth type space 2 illustrated in FIG. 2 is arranged irrespective of indoors or outdoors. For example, the booth type space 2 is arranged in a station yard, an airport, an office building, a commercial facility such as a restaurant or a department store, a bank, a library, an art gallery, a museum, a public institution or facility, an accessway, or a park.

The booth type space 2 illustrated in FIG. 2 is a closed booth having a ceiling. The term “closed” does not mean “sealed” and the closed booth only needs to have a practical sound-proof property. Therefore, an opening or clearance such as an air vent or a small window may be provided in a portion of a frame that defines the space 2. The window may be openable and closable.

The frame of the space 2 illustrated in FIG. 2 includes a ceiling 20A, a floor 20B, a wall 20C having an openable and closable door 22, two walls 20D and 20E located on both sides of the wall 20C, and a wall 20F located opposite the door 22.

In the case of FIG. 2, the ceiling 20A has a ventilating hole 23. A louver 23A capable of adjusting the opening area is attached to the ventilating hole 23. The louver 23A of FIG. 2 is fully open.

In this exemplary embodiment, the door 22 is assumed to be a sliding door movable along the wall 20C. In the case of FIG. 2, the door 22 is a single sliding door that slides in one direction. The door 22 may be a double sliding door to be opened or closed by moving two or more members in different directions, or a drawn door having two members slidable to right and left.

The door 22 is not limited to the sliding door. For example, the door 22 may be a single hinged door having one swingable member, or a double hinged door having one opening closed by two door members.

The door 22 may be a folding door to be opened by folding a pair of door members coupled by hinges. The folding door may be a folding door of a type in which door members are opened in one direction, or in which door members are opened in two directions.

As a special type of door, the door 22 may be a partition door or a retractable sliding door to be retracted into a wall when the door 22 is opened.

The door 22 may be opened inward or outward.

In this exemplary embodiment, the door 22 has a handle 22A to be gripped by a user when the door 22 is opened or closed.

A member 22B subjected to treatment in consideration of confidentiality and security is arranged at the center of the door 22. For example, the member 22B may be a transparent plate in which a metal plate having many arrays of holes (for example, a perforated metal) is attached on an inner side, a transparent plate in which a screen member is attached on an inner side with a clearance, a transparent plate having a film that makes it easy to view the inside from the front but difficult to view the inside in a slanting direction, or a transparent plate subjected to treatment for reducing internal visibility.

For example, glass or an acrylic resin is used for the transparent plate. A characteristic related to the transparency of the film bonded for confidentiality and security is determined based on a relationship between the position of the door 22 and the working position of the user. If the user works on a far side behind the front of the door 22, it is appropriate to use a film that makes it difficult to view the inside from the front but easy to view the inside in a slanting direction.

The film may be a liquid crystal film whose transparent state and opaque state are switchable electrically, or a polarizing film whose transmittance is controllable electrically.

Examples of the treatment for reducing visibility include finely scoring the surface of the member so that light is scattered.

The treatment may be performed on a portion of the member 22B. For example, the structure may be provided such that the member 22B is transparent near the floor and the ceiling and the visibility is reduced through the treatment in a range in which a monitor may be viewed during work.

By arranging the member 22B, the presence or absence of the user may be confirmed from the outside while hiding a screen of the monitor from the outside.

An electronic lock 22C unlockable with an electronic key is attached to the door 22.

The treatment in consideration of confidentiality and security may be performed on a member other than the door 22. For example, the treatment in consideration of confidentiality and security may be performed on at least a portion of the wall 20D, 20E, or 20F.

The number of users of the space 2 is roughly determined depending on the volume of the space 2. The space 2 illustrated in FIG. 2 is assumed to be a private room that is basically used alone. The space 2 according to this exemplary embodiment may be a large room capable of accommodating many people. The large room may be formed as a single room but may be formed by removing one or both of the walls 20D and 20E of the space 2 and coupling a plurality of spaces 2.

The private room does not mean that the room may be used alone but means that the room may be used by a few people such as two or three people.

The shape and structure of the frame that defines the space 2 and the provided equipment and performance thereof are arbitrary. For example, the ceiling 20A may be omitted.

In this exemplary embodiment, one desk and one chair (not illustrated) are arranged in the frame. Furnished equipment and devices or reserved equipment and devices are arranged on the desk.

The image capturing apparatus 24 such as a camera that captures an image of the inside of the frame and the motion sensor 25 that detects a user in the frame are provided in the frame. The information acquisition apparatus (not illustrated) that acquires information on each user of the space 2 may be provided on an outer side of the frame. For example, the information acquisition apparatus is a reader that reads an ID card held over the reader. The information acquisition apparatus may be a reader that reads a fingerprint or a vein pattern of a user.

In this exemplary embodiment, the image capturing apparatus 24 is used as an example of an image capturing unit.

### <Hardware Configurations of Apparatuses>

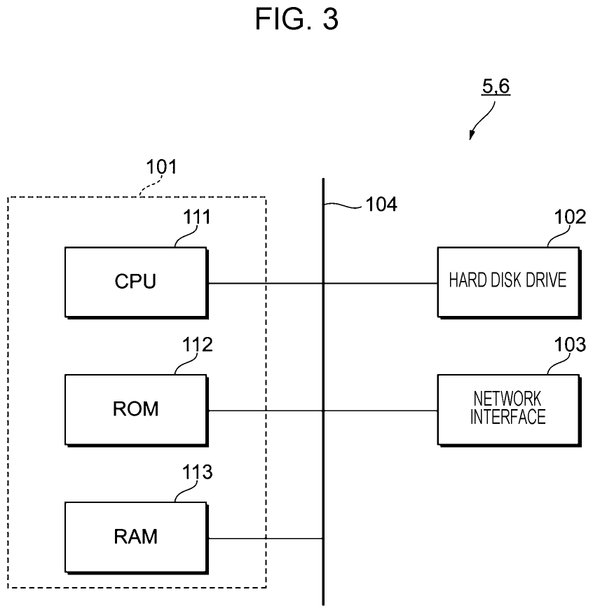

FIG. 3 illustrates an example of the hardware configuration of each management server for use in this exemplary embodiment. The management servers of this exemplary embodiment are the space management server 5 (see FIG. 1) and the attendance management server 6 (see FIG. 1).

The management server includes a control unit 101 that controls an overall operation of the apparatus, a hard disk drive 102 that stores management data and the like, and a network interface 103 that achieves communication via a local area network (LAN) cable or the like.

The control unit 101 includes a central processing unit (CPU) 111, a read only memory (ROM) 112 that stores basic software, a basic input/output system (BIOS), and the like, and a random access memory (RAM) 113 to be used as a working area. The CPU 111 may be a multi-core CPU. The ROM 112 may be a rewritable non-volatile semiconductor memory. The control unit 101 is a so-called computer.

The hard disk drive 102 is an apparatus that reads and writes data on a non-volatile storage medium obtained by applying a magnetic substance to the surface of a disc-shaped substrate. The non-volatile storage medium may be a semiconductor memory or a magnetic tape.

As necessary, the management server includes an input device such as a keyboard and a mouse, and a display device such as a liquid crystal display.

The control unit 101, the hard disk drive 102, and the network interface 103 are connected through a bus 104 and signal lines (not illustrated).

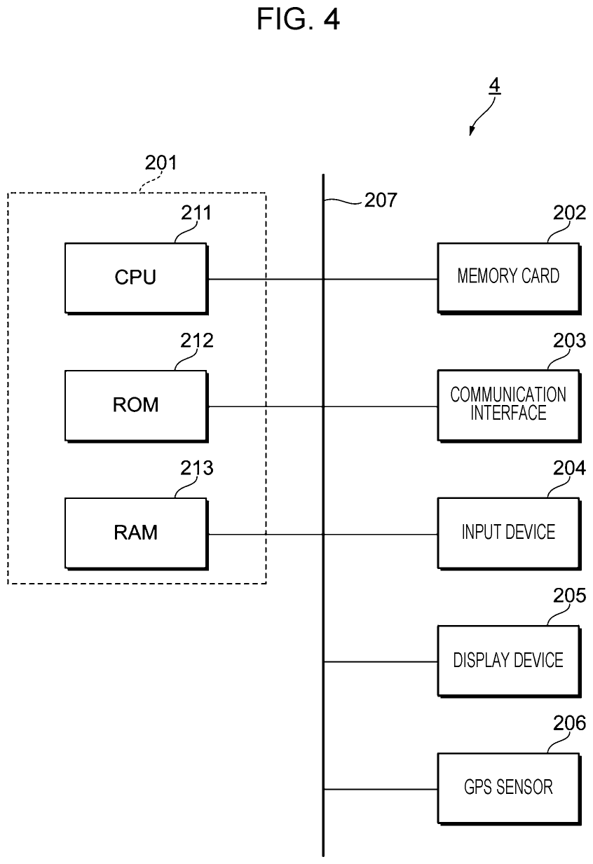

FIG. 4 illustrates an example of the hardware configuration of the user terminal 4. The configuration illustrated in FIG. 4 is assumed to be a configuration when the user terminal 4 is a smartphone.

The user terminal 4 includes a control unit 201 that controls an overall operation of the apparatus, a memory card 202 that stores various types of data, various types of communication interface 203 conforming to wireless communication standards, an input device 204 such as a touch sensor, a display device 205 such as a liquid crystal display or an organic electroluminescence (EL) display, a Global Positioning System (GPS) sensor 206, and a bus 207 that connects the respective parts.

The control unit 201 includes a CPU 211, a ROM 212 that stores firmware, a BIOS, and the like, and a RAM 213 to be used as a working area. The CPU 211 may be a multi-core CPU. The ROM 212 may be a rewritable non-volatile semiconductor memory.

For example, the communication interface 203 is an interface to be used for connection to the space management server 5 and the attendance management server 6, or an interface to be used for connection to a wireless LAN.

The GPS sensor 206 measures the position of the user terminal 4 by receiving an electric wave from a GPS satellite. Information on a latitude, a longitude, and an altitude output from the GPS sensor 206 provides a current position of the user terminal 4. The GPS sensor 206 may be compatible with an indoor positioning system.

### <Functional Configuration of Space Management Server>

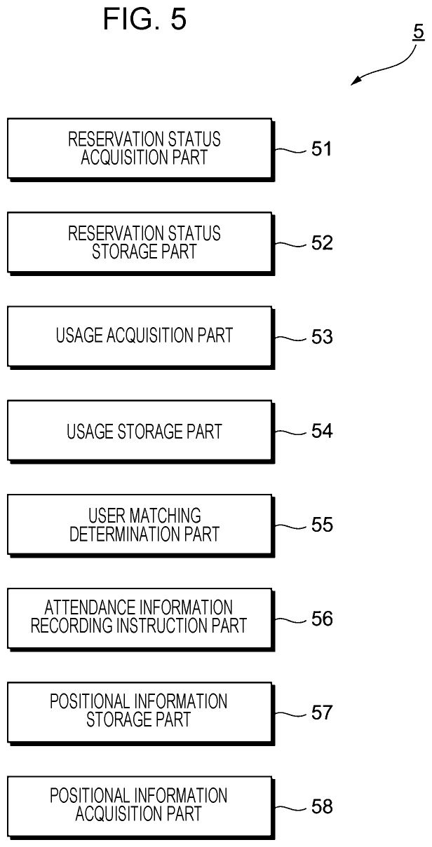

FIG. 5 illustrates an example of the functional configuration of the space management server 5. The space management server 5 includes a reservation status acquisition part 51, a reservation status storage part 52, a usage acquisition part 53, a usage storage part 54, a user matching determination part 55, an attendance information recording instruction part 56, a positional information storage part 57, and a positional information acquisition part 58.

The reservation status acquisition part 51 is an example of a reserving person information acquisition unit. The reservation status acquisition part 51 acquires various types of information related to a reservation for the space 2, for example, in response to a user input from the user terminal 4. As described above, examples of various types of information related to a reservation for the space 2 include information on a reserving person, information on the reserved space 2, and information on start time and date and end time and date of a time frame reserved by the reservation.

The reservation status storage part 52 stores the pieces of information acquired by the reservation status acquisition part 51.

The usage acquisition part 53 is an example of a user information acquisition unit and an activity information acquisition unit. The usage acquisition part 53 acquires various types of information related to a use of the space 2 from apparatuses such as the image capturing apparatus 24, the motion sensor 25, and the information acquisition apparatus (not illustrated). As described above, various types of information related to the use of the space 2 are, for example, information on a user who has come to the space 2, information on the space 2, and information on start time and date of use and end time and date of use.

The usage storage part 54 stores the pieces of information acquired by the usage acquisition part 53.

The user matching determination part 55 determines whether a reserving person and a user match each other based on information on the reserving person that is stored in the reservation status storage part 52 and information on the user that is stored in the usage storage part 54.

For example, when a user comes to the space 2 and information is stored in the usage storage part 54, the user matching determination part 55 acquires, from the usage storage part 54, information on the user who has come to the space 2. The user matching determination part 55 acquires, from the reservation status storage part 52, information on a reserving person registered as a person who is expected to use the space 2 at a time when the user has come to the space 2. Then, the user matching determination part 55 determines whether the reserving person and the user match each other by comparing the information on the reserving person and the information on the user.

The attendance information recording instruction part 56 is an example of an output unit. The attendance information recording instruction part 56 outputs, to the attendance management server 6, an instruction to record user's attendance information when the user matching determination part 55 determines that the reserving person and the user match each other. For example, the instruction includes information indicating that the user has worked in the space 2, the information on the user who has come to the space 2, the information on the space 2, and information on a working period, breaks, a start time of work, and an end time of work. When the instruction is received, the attendance management server 6 records the user's attendance information in the space 2.

The positional information storage part 57 collects, from all the user terminals 4, pieces of positional information of the user terminals 4 identified by the GPS sensor 206 and stores the collected pieces of positional information.

The positional information acquisition part 58 is an example of a positional information acquisition unit. The positional information acquisition part 58 acquires, from the positional information storage part 57, positional information collected from the user terminal 4 of the user as positional information of the user. Although details are described later, the acquired positional information is used to, for example, identify the working period of the user.

The functional parts of the space management server 5 are implemented in cooperation between a software resource and a hardware resource. Specifically, if the space management server 5 is implemented by the hardware configuration illustrated in FIG. 3, the functional parts such as the reservation status acquisition part 51, the usage acquisition part 53, the user matching determination part 55, the attendance information recording instruction part 56, and the positional information acquisition part 58 are implemented such that a program stored in the hard disk drive 102 is read on the RAM 113 and executed by the CPU 111. For example, the reservation status storage part 52, the usage storage part 54, and the positional information storage part 57 are implemented by the hard disk drive 102.

### <Processing to be Performed by Space Management Server>

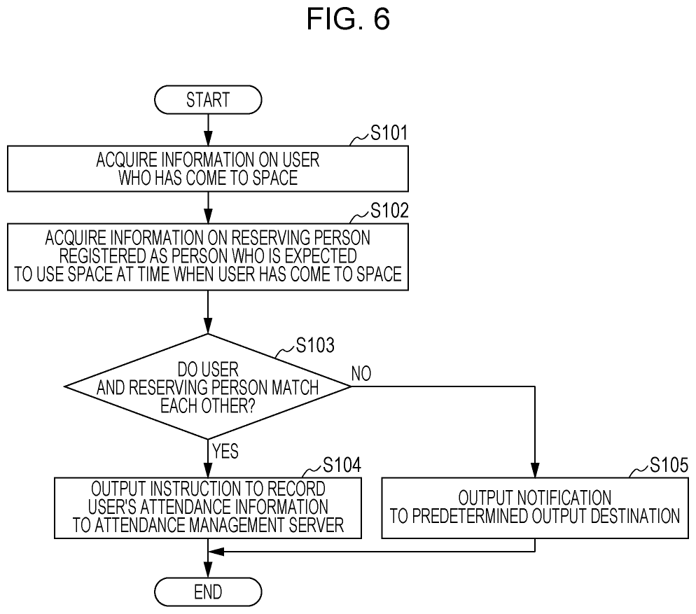

FIG. 6 is a flowchart illustrating an example of a procedure of processing to be performed by the space management server 5. Each processing step may hereinafter be represented by a symbol “S”.

First, when a user comes to the space 2 and information is stored in the usage storage part 54, the user matching determination part 55 acquires, from the usage storage part 54, information on the user who has come to the space 2 (S101). Specifically, the motion sensor 25 detects the user and the image capturing apparatus 24 captures an image of the user when the motion of the user is stopped. Then, the captured image of the user is stored in the usage storage part 54. The image of the user includes information on the face of the user. If the user holds an ID card over the information acquisition apparatus and the information acquisition apparatus reads information from the ID card, the read information is stored in the usage storage part 54. The user matching determination part 55 acquires those pieces of information from the usage storage part 54.

Next, the user matching determination part 55 acquires, from the reservation status storage part 52, information on a reserving person registered as a person who is expected to use the space 2 at a time when the user has come to the space 2 (S102). The user may come to the space 2 earlier than the beginning of the time frame reserved for the user. Therefore, the user matching determination part 55 may set a target period around the arrival of the user at the space 2 (for example, between the arrival of the user and 30 minutes after the arrival of the user), and may acquire information on reserving persons of reservations that have a reserved time frame at least partly overlapping with the target period.

Next, the user matching determination part 55 determines whether the user and the reserving person match each other by comparing the information on the user that is acquired in S101 and the information on the reserving person that is acquired in S102 (S103).

When the result of determination in S103 is positive (YES), the attendance information recording instruction part 56 outputs, to the attendance management server 6, an instruction to record user's attendance information (S104). The attendance information recording instruction part 56 may output a notification that the user who is the reserving person has properly used the space 2. Specifically, the attendance information recording instruction part 56 transmits a notification mail reporting that the user who is the reserving person has properly used the space 2 to a predetermined output destination such as a manager who manages work of the user who is the reserving person. Then, the processing flow is terminated.

When the result of determination in S103 is negative (NO), no attendance information is recorded for the user and the reserving person. The attendance information recording instruction part 56 outputs a notification to a predetermined output destination (S105). For example, the notification is output to report that the space 2 is not used properly. Specifically, the attendance information recording instruction part 56 transmits a notification mail reporting that a person different from the reserving person is using the space 2 to a predetermined output destination such as the reserving person or the manager who manages work of the reserving person. At this time, the information on the user such as the information on the face of the user is reported as well. For example, the attendance information recording instruction part 56 may output an alert to the user of the space 2 via a loudspeaker (not illustrated) provided in the space 2 to prompt the user to stop using the space 2. The alert may be displayed on a display device (not illustrated) such as a liquid crystal display provided in the space 2. Then, the processing flow is terminated.

In S105, the notification output destination and details of the notification may be varied depending on a relationship between the reserving person and the user. For example, if the reserving person and the user belong to the same company but to different departments, the attendance information recording instruction part 56 outputs a notification to an output destination such as a human resources department of the company. For example, information on the names, titles, and departments of the reserving person and the user is reported. For example, if the reserving person and the user belong to the same company and to the same department, the attendance information recording instruction part 56 outputs a notification to an output destination such as a manager of the department. For example, if the organization of the user is unknown, the attendance information recording instruction part 56 outputs a notification to an output destination such as a manager who manages the space 2. For example, the information on the face of the user is transmitted or a notification is output to prompt the manager to go to the space 2 because the space 2 may be misused.

For example, the organization of the user is grasped by extracting a person who matches the user from the information stored in the reservation status storage part 52 based on the captured image of the face of the user. For example, the organization may be grasped based on the ID card of the user.

Personal information such as the information on the face of the user may be prevented from being reported because the information needs careful handling.

### <Examples of Processing to be Performed by Space Management Server>

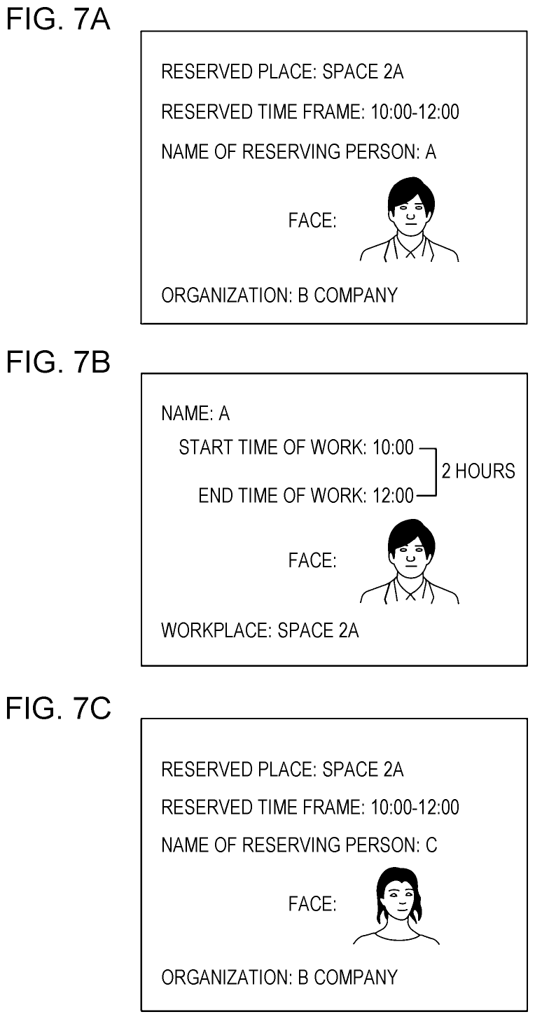

FIGS. 7A to 7C illustrate specific examples of the processing to be performed by the space management server 5. The following steps (that is, symbols “S”) correspond to the respective steps in FIG. 6.

In this example, a user A uses a space 2A. When the user A comes to the space 2A, for example, the motion sensor 25 detects the user A and the image capturing apparatus 24 captures an image of the user A. Then, the captured image of the user A is stored in the usage storage part 54. The user matching determination part 55 acquires information on the face of the user A based on the image of the user A that is stored in the usage storage part 54 (S101).

Next, the user matching determination part 55 acquires, from the reservation status storage part 52, information on a reserving person registered as a person who is expected to use the space 2A at a time when the user A has come to the space 2A (S102). When the user A comes to the space 2A at 10:00, the user matching determination part 55 acquires information on a reserving person registered as a person who is expected to use the space 2A at 10:00. The user A may come to the space 2A earlier than the beginning of the time frame reserved for the user A. Therefore, the user matching determination part 55 may set a target period around the arrival of the user A at the space 2A (in this example, 10:00 to 10:30), and may acquire information on reserving persons of any reservations that have a reserved time frame at least partly overlapping with the target period.

For example, as illustrated in FIG. 7A, the information on the reserving person registered as the person who is expected to use the space 2A at 10:00 is stored in the reservation status storage part 52. Specifically, information indicating that the reserved place is the space 2A, information indicating that the period registered as a period to use the space 2A (hereinafter referred to as “reserved time frame”) is 10:00 to 12:00, information indicating that the name of the reserving person is A (that is, the name of the user A), the information on the face of the user A, and the organization of the user A (in this example, a B company) are stored in the reservation status storage part 52.

The pieces of information illustrated in FIG. 7A are stored for each reservation. For example, in the space 2A, other reservations are made in a time range other than 10:00 to 12:00 and pieces of information on the other reservations are also stored in the reservation status storage part 52. Further, pieces of information on reservations for the spaces 2 other than the space 2A are also stored in the reservation status storage part 52.

Next, the user matching determination part 55 determines whether the user and the reserving person match each other by comparing the information on the user and the information on the reserving person (S103). In this example, the image of the face of the user A that is captured by using the image capturing apparatus 24 is compared with image of the face of the reserving person illustrated in FIG. 7A. Then, it is determined that the user and the reserving person match each other (YES in S103). Next, the attendance information recording instruction part 56 outputs, to the attendance management server 6, an instruction to record attendance information of the user A (S104).

In S104, the attendance information recording instruction part 56 may output, for example, only a notification that the user A has worked in the space 2A as the instruction to record the attendance information of the user A. The attendance information recording instruction part 56 may report a start time of work, an end time of work, a working period, and the like. For example, the start time of work is a time when the user A enters the space 2A. For example, the end time of work is a time when the user A exits from the space 2A. For example, the working period is a period from the start time to the end time of work. In this example, as illustrated in FIG. 7B, a notification that the start time of work is 10:00, the end time of work is 12:00, the working period is 2 hours, the image of the user A is captured, and the workplace is the space 2A is output as the attendance information of the user A.

For example, the exit of the user from the space 2A is grasped when the image of the user is no longer captured by the image capturing apparatus 24 or detected by the motion sensor 25. The exit of the user may be grasped such that the user holds an ID card over the information acquisition apparatus when the user exits from the space 2A.

The user A may come to the space 2A earlier than 10:00 that is the start time of the time frame reserved by the reservation or may stay in the space 2A even after 12:00 that is the end time of the time frame reserved by the reservation. Therefore, if the user A enters the space 2A before the start of the time frame reserved by the reservation, the start time of work may be an actual time of entry to the space 2A (that is, a time before 10:00) but may be 10:00 that is the start time of the reserved time frame. If the user A stays in the space 2A even after 12:00, the end time of work may be an actual time of exit from the space 2A (that is, a time after 12:00) but may be 12:00 that is the end time of the time frame reserved by the reservation.

The working period may be grasped based on a period of use of equipment provided in the space 2A. For example, the start time of work may be a time when a personal computer (PC) provided in the space 2A is started after the user A has entered the space 2A and the end time of work may be a time when the PC is shut down. For example, if the PC is started earlier than the start time of the time frame reserved by the reservation, the start time of work may be a time when the PC is started or may be the start time of the time frame reserved by the reservation. Similarly, if the user continues to use the PC even after the end time of the time frame reserved by the reservation, the end time of work may be a time when the PC is shut down or may be the end time of the time frame reserved by the reservation.

As needed, the user A may exit from the space 2A and re-enter the space 2A within the reserved time frame. In this case, the attendance information recording instruction part 56 may output the instruction to record the attendance information based on a period from the exit of the user A from the space 2A to the re-entry of the user A to the space 2A.

For example, the attendance information recording instruction part 56 may set the period from the exit of the user A from the space 2A to the re-entry of the user A to the space 2A as a break instead of the working period. In this case, the attendance information recording instruction part 56 may notify the attendance management server 6 of the length of the break or of the period excluding the break as the working period.

The space management server 5 may prompt the user A to input information on an action conducted in the period from the exit from the space 2A to the re-entry to the space 2A. The user A inputs information on the action conducted in this period by using the user terminal 4 or the like. Examples of the information on the action include details of the action, a visited place, and a reason for exit. Specifically, the information may indicate that “the user A exited from the space 2 for a meal”, “the user A purchased office supplies”, or “the user A went to the restroom”. The attendance information recording instruction part 56 outputs, to the attendance management server 6, the information input by the user A.

The user A may choose whether the period from the exit from the space 2A to the re-entry to the space 2A is set as a part of the working period (or set as a break). The attendance information recording instruction part 56 may determine whether the period is a part of the working period (or a break) based on the information input by the user A. Specifically, if the user A inputs information indicating that the user A had a meal in the period from the exit from the space 2A to the re-entry to the space 2A, the attendance information recording instruction part 56 determines that the period is a break instead of a part of the working period. For example, if the user A inputs information indicating that the user A purchased office supplies in the period from the exit from the space 2A to the re-entry to the space 2A, the attendance information recording instruction part 56 determines that the period is the working period.

The attendance information recording instruction part 56 may determine whether the period is the working period based on positional information of the user A. In this case, the positional information acquisition part 58 acquires, from the positional information storage part 57, positional information collected from the user terminal 4 of the user A as the positional information of the user A. Specifically, the positional information acquisition part 58 acquires positional information of the user A in the period from the exit of the user A from the space 2A to the re-entry of the user A to the space 2A. Then, the attendance information recording instruction part 56 identifies a place visited by the user A based on the acquired positional information. For example, if the place visited by the user A is a restaurant, the attendance information recording instruction part 56 determines that the period from the exit of the user A from the space 2A to the re-entry of the user A to the space 2A is a break instead of a part of the working period. For example, if the place visited by the user A is a shop that sells office supplies, the attendance information recording instruction part 56 determines that the period from the exit of the user A from the space 2A to the re-entry of the user A to the space 2A is the working period.

Next, description is made of a case in which the reserving person is not the user A unlike the example illustrated in FIG. 7A. Specifically, information indicating that the reserved place is the space 2A, information indicating that the reserved time frame is 10:00 to 12:00, information indicating that the name of the reserving person is C (that is, the name of a user C), information on the face of the user C, and the organization of the user C (in this example, the B company) are stored as illustrated in FIG. 7C.

The user matching determination part 55 determines whether the user and the reserving person match each other by comparing the information on the user and the information on the reserving person (S103). In this example, the image of the face of the user A that is captured by using the image capturing apparatus 24 is compared with the image of the face illustrated in FIG. 7C. Then, it is determined that the user and the reserving person do not match each other (NO in S103). Thus, no attendance information is recorded for the user A and the user C. The attendance information recording instruction part 56 outputs a notification to a predetermined output destination (S105). In this example, the user C who is the reserving person is in common with the user A in that the organization is the B company. Therefore, the attendance information recording instruction part 56 transmits, for example, a notification mail reporting that the user A different from the user C who is the reserving person is using the space 2A to a human resources department of the B company.

If the reserving person and the user do not match each other but have a predetermined relationship, user's attendance information may be recorded. For example, the predetermined relationship is a relationship in which the reserving person and the user belong to the same organization. In the example illustrated in FIG. 7C, the user C who is the reserving person and the user A belong to the B company that is the same organization. Therefore, the reserving person and the user do not match each other but have the predetermined relationship. Thus, the attendance information of the user A is recorded. In this case, the attendance information recording instruction part 56 outputs, to the attendance management server 6, an instruction to record the attendance information of the user A.

For example, the predetermined relationship is a relationship in which the reserving person permits the user to use the space 2. Specifically, the reserving person is regarded to give a permission when an authentication code indicating that the reserving person gives a permission is issued to the user. For example, the reserving person is regarded to give a permission when an electronic key provided in advance is transmitted from the reserving person to the user. In this case, the attendance information recording instruction part 56 outputs, to the attendance management server 6, an instruction to record the user's attendance information.

The predetermined relationship is not limited to those examples. For example, a user who may use the space 2 on behalf of the reserving person may be registered in advance as the user having the predetermined relationship with the reserving person.

<Processing to be Performed when Plurality of Users Come to Space>

When a plurality of users come to the space 2, the users and reserving persons match each other if all the plurality of users are stored in the reservation status storage part 52 as the reserving persons. In this case, the attendance information recording instruction part 56 outputs, to the attendance management server 6, an instruction to record pieces of attendance information of the users. If a user who is not stored as the reserving person is present among the plurality of users, the users and the reserving persons do not match each other. In this case, the attendance information recording instruction part 56 outputs a notification to a predetermined output destination.

If a user who is not stored as the reserving person is present among the plurality of users but the reserving person is included in the plurality of users, it may be determined that the users and the reserving persons match each other.

For example, if a plurality of users come to the space 2 and a user who is not stored as the reserving person is present among the plurality of users but the reserving person is included in the plurality of users, the attendance information recording instruction part 56 outputs, to the attendance management server 6, an instruction to record attendance information. In this case, the attendance information recording instruction part 56 outputs an instruction to record attendance information of the user who is the reserving person. The attendance information recording instruction part 56 may output an instruction to record attendance information of the user who is not stored as the reserving person among the plurality of users. Attendance information may be recorded only for a user having the predetermined relationship with the reserving person instead of all the users who are not stored as the reserving persons. For example, if a user who is the reserving person and a user who is not the reserving person come to the space 2 and belong to the same organization, attendance information is recorded for the user who is not the reserving person as well as the user who is the reserving person.

If a plurality of users come to the space 2 and a user who is not stored as the reserving person is present among the plurality of users but the reserving person is included in the plurality of users, the attendance information recording instruction part 56 may avoid outputting a notification to a predetermined output destination. If the reserving person is included in the plurality of users but the space 2 satisfies a predetermined condition, the attendance information recording instruction part 56 may output the notification to the predetermined output destination. For example, the predetermined condition is a condition that the use of the space 2 by a plurality of persons is prohibited. For example, the predetermined condition is a condition that the space 2 is beyond capacity because users more than the capacity of the space 2 come to the space 2. When those conditions are satisfied, the attendance information recording instruction part 56 outputs the notification to the predetermined output destination even if the reserving person is included in the plurality of users who come to the space 2.

<Processing to be Performed when User Exits from Space and then Enters Different Space>

The user may exit from a space 2 and then enter a different space 2. In this case, a period from the exit of the user from the space 2 to the entry of the user to the different space 2 may be set as the working period. In other words, a movement period from the space 2 to the different space 2 may be set as the working period.

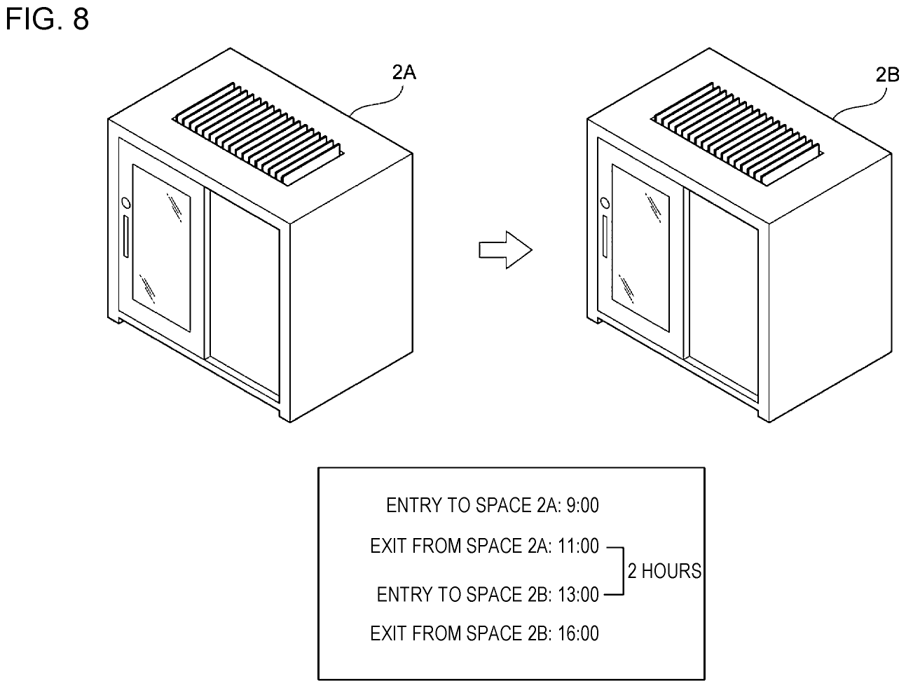

FIG. 8 illustrates an example of processing to be performed when a person exits from a space 2 and then enters a different space 2.

In this example, the user A uses and exits from the space 2A and then enters a space 2B. Specifically, the user A enters the space 2A at 9:00 and exits from the space 2A at 11:00. Then, the user A moves from the space 2A to the space 2B. Then, the user A enters the space 2B at 13:00 and exits from the space 2B at 16:00. The user A makes a reservation for the use of the space 2A from 9:00 to 11:00 prior to the use of the space 2A. Similarly, the user A makes a reservation for the use of the space 2B from 13:00 to 16:00 prior to the use of the space 2B.

In this case, 2 hours from 11:00 to 13:00 are a movement period from the space 2A to the space 2B. The attendance information recording instruction part 56 outputs an instruction to record attendance information of the user A while determining that the movement period of 2 hours is the working period. In the example illustrated in FIG. 8, the attendance information recording instruction part 56 outputs the instruction to record the attendance information of the user A while determining that a period from 9:00 to 16:00 is the working period. The attendance information recording instruction part 56 may report the period from 9:00 to 16:00 as the working period or details of the working period in the instruction to record the attendance information. Specifically, the attendance information recording instruction part 56 may report a period from 9:00 to 11:00 as a working period in the space 2A, a period from 11:00 to 13:00 as a working period for movement, and a period from 13:00 to 16:00 as a working period in the space 2B.

During a period in which the user is not actually moving in the movement period from the space 2 to the different space 2, the user may be doing an activity irrelevant to work. Therefore, the period in which the user is not moving may be excluded from the working period. For example, the period in which the user is not moving is a period in which the position indicated by the positional information does not change. For example, the period in which the user is not moving is a period in which the amount of change in the position indicated by the positional information per unit time is smaller than a threshold.

In the example illustrated in FIG. 8, the positional information acquisition part 58 acquires, from the positional information storage part 57, positional information collected from the user terminal 4 of the user A as the positional information of the user A. Specifically, the positional information acquisition part 58 acquires positional information of the user A in the period from the exit of the user A from the space 2A to the entry of the user A to the space 2B, in other words, positional information of the user A from 11:00 to 13:00. Then, the attendance information recording instruction part 56 identifies a period in which the user A is not moving based on the acquired positional information. If 30 minutes are identified as the period in which the user A is not moving out of the period from 11:00 to 13:00, the attendance information recording instruction part 56 notifies the attendance management server 6 that 1 hour and 30 minutes remaining through subtraction of 30 minutes in which the user A is not moving are the working period of the user A for movement.

If the period from the exit of the user from the space 2 to the entry of the user to the different space 2 exceeds a predetermined period, the user may be doing an activity irrelevant to work. Therefore, an excess period may be excluded from the working period.

In the example illustrated in FIG. 8, the period from the exit from the space 2A to the entry to the space 2B is 2 hours. It is assumed that a period required to move from the space 2A to the space 2B is generally 1 hour and 30 minutes. In this case, the user A may be doing an activity irrelevant to work somewhere during 30 minutes exceeding 1 hour and 30 minutes. Therefore, the excess of 30 minutes is excluded from the working period. The attendance information recording instruction part 56 notifies the attendance management server 6 that 1 hour and 30 minutes remaining through subtraction of the excess of 30 minutes are the working period of the user A for movement.

<Processing to be Performed when Activity Information is Recorded as Attendance Information>

In this exemplary embodiment, the usage acquisition part 53 may acquire information on an activity conducted by the user in the space 2 (the information on the activity is hereinafter referred to as “activity information”). In this case, the attendance information recording instruction part 56 outputs, to the attendance management server 6, the activity information acquired by the usage acquisition part 53 as information corresponding to the attendance information of the user in the space 2.

More specifically, the usage acquisition part 53 acquires activity information obtained by capturing an image of the user with the image capturing apparatus 24 or activity information input by the user on the user terminal 4 or the like. For example, the activity information may indicate that “the user used the PC provided in the space 2”, “the user reviewed a material”, or “the user rehearsed a presentation”. If the user inputs the activity information on the user terminal 4 or the like, the user may input further details as to what kind of work was conducted by using the PC, what kind of material was reviewed, or what kind of presentation was rehearsed.

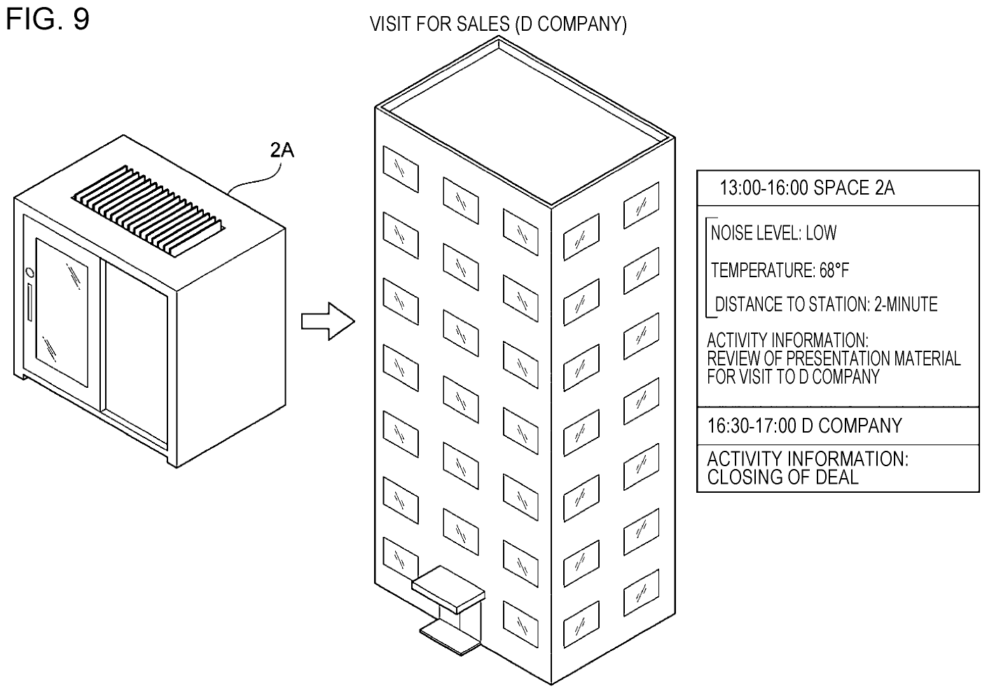

FIG. 9 illustrates an example of processing to be performed when the activity information is recorded as the attendance information.

In this example, the user A uses the space 2A from 13:00 to 16:00, exits from the space 2A, and then visits a D company for sales. The user A inputs information on an activity conducted in the space 2A during the use of the space 2A or after the visit to the D company. Then, the usage acquisition part 53 acquires the input activity information. The attendance information recording instruction part 56 outputs, to the attendance management server 6, the activity information acquired by the usage acquisition part 53 as information corresponding to the attendance information of the user A in the space 2A.

The user A also inputs information on an activity conducted in the D company after the visit to the D company. The usage acquisition part 53 also acquires this activity information. Then, the attendance information recording instruction part 56 outputs, to the attendance management server 6, the activity information in the D company as the activity information of the user A in the space 2A or the information corresponding to the attendance information of the user A in the space 2A.

This example shows that the user A reviewed a presentation material for the visit to the D company as the activity information in the space 2A. Further, this example shows that a deal was closed as the activity information in the D company. The attendance management server 6 stores those pieces of activity information in association with each other. Therefore, it is possible to grasp that the user A reviewed the presentation material in the space 2A before the deal was closed in the D company. By storing the information on what kind of action was conducted before the deal was closed in order to, for example, compensate for insufficient preparation for a negotiation, the information is used as a reference for future negotiations of the user A or negotiations of users other than the user A, thereby leading to improvement in business.

The attendance information recording instruction part 56 may output, to the attendance management server 6, information on an environment of the space 2 as information corresponding to the activity information in the space 2. Examples of the information on the environment of the space 2 include a noise level in the space 2, a temperature of the space 2, and a value of the location of the space 2. The value of the location of the space 2 is a degree of usefulness of the location of the space 2. Examples thereof include a distance from the space 2 to a station, a distance from the space 2 to the center of a city, the number of reservations, and the number of users. In the example illustrated in FIG. 9, the attendance information recording instruction part 56 outputs a noise level in the space 2A, a temperature of the space 2A, and a distance from the space 2A to a station as information on an environment of the space 2A.

For example, the noise level is detected by a noise meter (not illustrated) provided in the space 2. For example, the temperature is detected by a thermometer (not illustrated) provided in the space 2. For example, the distance to a station is preset by the manager of the space 2. By storing the information on the environment of the space 2 used before the deal was closed in order to, for example, compensate for insufficient preparation for the negotiation, the information is used as a reference for future negotiations of the user A or negotiations of users other than the user A, thereby leading to improvement in business.

In the information on the environment of the space 2, the information such as the noise level or the temperature, which changes with an elapse of time, may be information detected at a specific time or information actually detected in the space 2 when the user conducts an activity in the space 2.

In the example illustrated in FIG. 9, the attendance information recording instruction part 56 outputs both the activity information in the space 2A and the information on the environment of the space 2A to the attendance management server 6 but may output one of those pieces of information.

In the example illustrated in FIG. 9, the activity information in the space 2 and the activity information after the exit from the space 2 are regarded as pieces of information different from the attendance information but those pieces of activity information may be regarded as portions of the attendance information.

In this exemplary embodiment, the user may directly input the activity information to the attendance management server 6 on the user terminal 4 or the like without outputting the activity information to the attendance management server 6 by the attendance information recording instruction part 56.

### Other Exemplary Embodiments

In this exemplary embodiment, the attendance management server 6 may execute a subset of the functions of the space management server 5 or all the functions. For example, the attendance management server 6 may perform the processing to be performed by the user matching determination part 55. In this case, the attendance management server 6 acquires various types of information related to reservations for the space 2 and various types of information related to a use of the space 2 from the space management server 5. Then, the attendance management server 6 determines whether the reserving person and the user match each other by comparing the information on the reserving person and the information on the user. When the attendance management server 6 determines that the reserving person and the user match each other, the attendance management server 6 records user's attendance information. In this case, the attendance management server 6 may be regarded to comprise a reservation information acquisition unit, the user information acquisition unit, and a recording unit.

As described above, the attendance management server 6 acquires, from the space management server 5, the information on the activity conducted by the user in the space 2 and the information on the environment of the space 2. Further, the attendance management server 6 acquires the information on the activity conducted after the user has exited from the space 2. Then, the attendance management server 6 records the information on the activity conducted by the user in the space 2 and the attendance information of the user in the space 2 in association with each other. Further, the attendance management server 6 records the information on the activity conducted by the user in the space 2 and the information on the activity conducted after the exit from the space 2 in association with each other. At this time, the information on the environment of the space 2 is also recorded in association. In this case, the attendance management server 6 may be regarded to comprise the activity information acquisition unit.

The program that implements the exemplary embodiment of the present disclosure may be provided by a communication unit and may also be provided by being stored in a recording medium such as a CD-ROM.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system, comprising:
a reserving person information acquisition unit that acquires information on a reserving person of a reservation for a place;
a user information acquisition unit that acquires information on a user who has come to the place; and
an output unit that outputs an instruction to record attendance information of the user if the reserving person and the user match each other based on the acquired information on the reserving person and the acquired information on the user.

2. The information processing system according to claim 1,
wherein the reserving person information acquisition unit acquires biological information of the reserving person, and
wherein the user information acquisition unit acquires biological information of the user.

3. The information processing system according to claim 2,
wherein the reserving person information acquisition unit acquires information on a face of the reserving person as the biological information of the reserving person, and
wherein the user information acquisition unit acquires information on a face of the user as the biological information of the user based on an image obtained by an image capturing unit provided in the place.

4. The information processing system according to claim 1, wherein, if the reserving person and the user do not match each other, the output unit outputs a notification to a predetermined output destination.

5. The information processing system according to claim 4, wherein the predetermined output destination varies depending on a relationship between the reserving person and the user.

6. The information processing system according to claim 4, wherein, if a plurality of users come to the place and the reserving person is included in the plurality of users, the output unit avoids outputting the notification to the predetermined output destination.

7. The information processing system according to claim 6, wherein, if the reserving person is included in the plurality of users but the place satisfies a predetermined condition, the output unit outputs the notification to the predetermined output destination.

8. The information processing system according to claim 1, wherein, if a plurality of users come to the place and the reserving person is included in the plurality of users, the output unit outputs an instruction to record attendance information of the reserving person.

9. The information processing system according to claim 8, wherein the output unit outputs an instruction to record attendance information of one or more users other than the reserving person among the plurality of users.

10. The information processing system according to claim 1, wherein, if the reserving person and the user do not match each other but have a predetermined relationship, the output unit outputs the instruction to record attendance information of the user.

11. The information processing system according to claim 10, wherein the predetermined relationship is that the reserving person and the user belong to the same organization.

12. The information processing system according to claim 10, wherein the predetermined relationship is that the actual user has received a permission to use the place from the reserving person.

13. The information processing system according to claim 1, wherein the attendance information includes a start time of work and an end time of work,
wherein the output unit outputs the instruction to record attendance information of the user such that a time of entry of the user to the place is regarded as the start time of work and a time of exit of the user from the place is regarded as the end time of work.

14. The information processing system according to claim 13,
wherein, if the time of entry of the user to the place is earlier than a start time of a time frame reserved by the reservation, the output unit outputs the instruction to record attendance information of the user such that the start time of the time frame is regarded as the start time of work, and
wherein, if the time of exit of the user from the place is later than an end time of the time frame, the output unit outputs the instruction to record attendance information of the user such that the end time of the time frame is regarded as the end time of work at the place.

15. The information processing system according to claim 1, wherein, in a case where the user exits from the place and re-enters the place within a time frame reserved by the reservation, the output unit outputs the instruction to record the attendance information of the user based on a period from the exit of the user from the place to the re-entry of the user to the place.

16. The information processing system according to claim 15, wherein the output unit outputs the instruction to record attendance information of the user such that the period from the exit of the user from the place to the re-entry of the user to the place is regarded as a break.

17. The information processing system according to claim 15, wherein the user is prompted to input information on an action conducted in the period from the exit of the user from the place to the re-entry of the user to the place.

18. The information processing system according to claim 1, wherein, in a case where the user exits from the place and then enters a different place, the output unit outputs the instruction to record attendance information of the user such that a period from the exit of the user from the place to the entry of the user to the different place is regarded as a working period.

19. The information processing system according to claim 18, further comprising a positional information acquisition unit that acquires positional information of the user,
wherein a period during which the user is not moving is excluded from the working period.

20. The information processing system according to claim 18, wherein, if the period from the exit of the user from the place to the entry of the user to the different place exceeds a predetermined period, an excess period is excluded from the working period.

21. The information processing system according to claim 1, further comprising an activity information acquisition unit that acquires information on an activity conducted by the user in the place,
wherein the output unit outputs the information on the activity as information corresponding to the attendance information in the place.

22. The information processing system according to claim 21, wherein the output unit outputs information on an environment of the place as information corresponding to the information on the activity.

23. An information processing system, comprising:
a reserving person information acquisition unit that acquires information on a reserving person of a reservation for a place;
a user information acquisition unit that acquires information on a user who has come to the place; and
a recording unit that records attendance information of the user if the reserving person and the user match each other based on the acquired information on the reserving person and the acquired information on the user.

24. The information processing system according to claim 23, further comprising an activity information acquisition unit that acquires information on an activity conducted by the user,
wherein the recording unit records information on an activity conducted by the user in the place and the attendance information in the place in association with each other.

25. The information processing system according to claim 24, wherein the recording unit records the information on the activity and information on an activity conducted by the user after the user has exited from the place in association with each other.

26. The information processing system according to claim 25, wherein the recording unit further records information on an environment of the place in association with the information on the activity.

27. The information processing system according to claim 26, wherein the information on the environment of the place is information detected in the place when the user conducts the activity in the place.

28. A non-transitory computer readable medium storing a program causing a computer to execute a process comprising:
acquiring information on a reserving person of a reservation for a place;
acquiring information on a user who has come to the place; and
outputting an instruction to record attendance information of the user if the reserving person and the user match each other based on the acquired information on the reserving person and the acquired information on the user.

29. A non-transitory computer readable medium storing a program causing a computer to execute a process comprising:
acquiring information on a reserving person of a reservation for a place;
acquiring information on a user who has come to the place; and
recording attendance information of the user if the reserving person and the user match each other based on the acquired information on the reserving person and the acquired information on the user.
